(19) United States
(12) Patent Application Publication
(10) Pub. No.: US 2010/0062332 A1
(43) Pub. Date: Mar. 11, 2010

(54) LITHIUM ION SECONDARY BATTERY

(75) Inventor: Tomokazu Kumeuchi, Sendai-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NEC TOKIN CORPORATION, Sendai-shi (JP)

(21) Appl. No.: 12/555,645

(22) Filed: Sep. 8, 2009

(30) Foreign Application Priority Data
Sep. 8, 2008 (JP) 2008-229538

(51) Int. Cl. H01M 10/26

(52) U.S. Cl. 429/200; 429/188

(57) ABSTRACT

A lithium ion secondary battery shows excellent charge/discharge properties and also excellent storage properties. The lithium ion secondary battery includes an aprotic electrolyte containing a sulfonate ester having at least two sulfonyl groups and graphite as principal component of negative electrode active substance layers, the density of the negative electrode active substance layers being not less than 0.90 g/cm³ and not more than 1.65 g/cm³.

### CROSS-REFERENCE TO RELATED APPLICATIONS

This application is based upon and claims the benefit of priority from prior Japanese Patent Application No. 2008-229538, filed Sep. 8, 2008, the entire contents of which are incorporated herein by reference.

### TECHNICAL FIELD

The present invention relates to a lithium ion secondary battery formed by using electrolyte containing a sulfonate ester having at least two sulfonyl groups and a negative electrode containing graphite.

### BACKGROUND ART

Lithium ion secondary batteries are being broadly employed in portable type battery operated devices such as mobile phones because they have a large charge/discharge capacity. Furthermore, there is a demand for high-efficiency secondary batteries having a large charge/discharge capacity in applications including electric bicycles, electric automobiles, power tools and electric power storages.

Various materials and techniques have been proposed to date to improve the properties, the long term charge/discharge cycle properties and the long term storage properties in particular, of lithium ion secondary batteries. As such techniques, non-aqueous electrolyte secondary batteries using aprotic electrolyte containing a sulfonate ester having at least two sulfonyl groups have been proposed.

However, lithium ion secondary batteries formed by using an aprotic electrolyte containing a sulfonate ester having at least two sulfonyl groups and graphite are accompanied by a problem that a lithium compound is deposited on the graphite negative electrode to degrade the charge/discharge cycle properties of the battery by the first charging operation after the completion of preparation of the battery.

### SUMMARY OF INVENTION

### Technical Problem

Therefore, it is the object of the present invention to provide a lithium ion secondary battery including an aprotic electrolyte containing a sulfonate ester having at least two sulfonyl groups and graphite as principal component of negative electrode active substance layers that does not deposit any lithium compound on the graphite negative electrode at the time of the first charging operation after the completion of preparation of the battery and shows excellent charge/discharge cycle properties and also excellent storage properties for a long time.

### Solution to Problem

The inventors of the present invention found that, in lithium ion secondary batteries including an aprotic electrolyte containing a sulfonate ester having at least two sulfonyl groups and graphite as principal component, no lithium compound is deposited on the negative electrode active substance layers when the density of the negative electrode active substance layers is within a predetermined range. They also found that an effect of suppressing the production of a substance on the negative electrode active substance layers is achieved when the electrolyte volume and the void volume that the positive electrode, the negative electrode and the separator possess show a predetermined relationship. The present invention is based on these finding.

According to the present invention, the above object of the invention is achieved by providing a lithium ion secondary battery including an aprotic electrolyte containing a sulfonate ester having at least two sulfonyl groups and graphite as principal component of negative electrode active substance layers, the density of the negative electrode active substance layers being not less than 0.90 g/cm³ and not more than 1.65 g/cm³.

Preferably, the electrolyte volume is not less than 1.25 times and not more than 1.65 times of the void volume that the positive electrode, the negative electrode and the separator possess.

The sulfonate ester having at least two sulfonyl groups may be a cyclic sulfonate ester expressed by chemical formula 1 shown below:

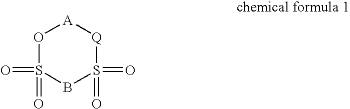

where Q is an oxygen atom, a methylene group or a single bond, A is a substituted or unsubstituted alkylene, carbonyl or sulfinyl group having 1 to 5 carbon atoms, a substituted or unsubstituted fluoroalkylene group having 1 to 6 carbon atoms or a group having 2 to 6 carbon atoms where alkylene units or fluoroalkylene units are bonded by way of an ether bond and B is a substituted or unsubstituted alkylene group, a substituted or unsubstituted fluoroalkylene group or an oxygen atom.

The sulfonate ester having at least two sulfonyl groups may be a chain sulfonate ester expressed by chemical formula 2 shown below:

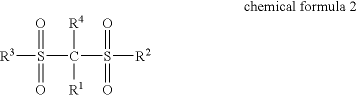

where each of R¹ and R⁴ is independently an atom or a group selected from a hydrogen atom, a substituted or unsubstituted alkyl group having 1 to 5 carbon atoms, a substituted or unsubstituted alkoxy group having 1 to 5 carbon atoms, a substituted or unsubstituted perfluoroalkyl group having 1 to 5 carbon atoms, a polyfluoroalkyl group having 1 to 5 carbon atoms, —SO₂X¹ (X¹ being a substituted or unsubstituted alkyl group having 1 to 5 carbon atoms), —SY¹ (Y¹ being a substituted or unsubstituted alkyl group having 1 to 5 carbon atoms), —COZ (Z being a hydrogen atom or a substituted or unsubstituted alkyl group having 1 to 5 carbon atoms) and a halogen atom and each of R² and R³ is independently an atom or a group selected from a substituted or unsubstituted alkyl group having 1 to 5 carbon atoms, a substituted or unsubstituted alkoxy group having 1 to 5 carbon atoms, a substituted or unsubstituted phenoxy group, a substituted or unsubstituted fluoroalkyl group having 1 to 5 carbon atoms, a substituted or unsubstituted polyfluoroalkyl group having 1 to 5 carbon atoms, a substituted or unsubstituted perfluoroalkoxy group having 1 to 5 carbon atoms, a substituted or unsubstituted polyfluoroalkoxy group having 1 to 5 carbon atoms, a hydroxyl group, a halogen atom, —NX²X³ (each of X² and X³ being independently a hydrogen atom or a substituted or unsubstituted alkyl group having 1 to 5 carbon atoms) and —NY²CONY³Y⁴ (each of Y² through Y⁴ being independently a hydrogen atom or a substituted or unsubstituted alkyl group having 1 to 5 carbon atoms).

### ADVANTAGEOUS EFFECTS OF INVENTION

Thus, according to the present invention, it is possible to improve the charge/discharge cycle properties and the storage properties of a lithium ion secondary battery including aprotic electrolyte containing a sulfonate ester having at least two sulfonyl groups and graphite as principal component of negative electrode active substance layers without forming lithium compounds on the negative electrode active substance layers by making the negative electrode active substance density not less than 0.90 g/cm³ and not more than 1.65 g/cm³. Additionally, the production of a lithium compound on the negative electrode active substance layers is suppressed by making the aprotic electrolyte volume containing a sulfonate ester having at least two sulfonyl groups not less than 1.25 times and not more than 1.65 times of the void volume that the positive electrode, the negative electrode and the separator possess.

### BRIEF DESCRIPTION OF THE DRAWINGS

The invention will be described with reference to the accompanying drawings, wherein like numbers reference like elements.

FIG. 1 is a schematic cross-sectional view of an example of stacked lithium ion secondary battery according to the present invention.

FIG. 2 is a photograph of the surface of an active substance layer of the negative electrode of the lithium ion secondary battery according to Example 1 of the present invention.

FIG. 3 is a photograph of the surface of an active substance layer of the negative electrode of the lithium ion secondary battery according to Example 4 of the present invention.

FIG. 4 is a photograph of the surface of an active substance layer of the negative electrode of the lithium ion secondary battery of Comparative Example 1.

FIG. 5 is a photograph of the surface of an active substance layer of the negative electrode of the lithium ion secondary battery of Comparative Example 2.

FIG. 6 is a graph illustrating some of the results of a cycle properties test conducted on the lithium ion secondary batteries of the Examples and the Comparative Examples of the present invention.

### DESCRIPTION OF EMBODIMENTS

According to the present invention, it is possible to improve the charge/discharge properties and the storage properties of a lithium ion secondary battery including aprotic electrolyte containing a sulfonate ester having at least two sulfonyl groups and graphite as principal component of negative electrode active substance layers without forming lithium compounds on the negative electrode active substance layers by making the negative electrode active substance density not less than 0.90 g/cm³ and not more than 1.65 g/cm³. Additionally, the production of a lithium compound on the negative electrode active substance layers is suppressed by making the aprotic electrolyte volume containing a sulfonate ester having at least two sulfonyl groups not less than 1.25 times and not more than 1.65 times of the void volume that the positive electrode, the negative electrode and the separator possess.

Now, the present invention will be described in greater detail by referring to the accompanying drawings that illustrate a preferred embodiment of the present invention.

FIG. 1 is a schematic cross-sectional view of the embodiment of the present invention, which is a stacked lithium ion secondary battery. The stacked lithium ion secondary battery 1 includes a battery element 3 formed by laying positive electrodes 10 and negative electrodes 20 one on the other by way of separators 30 and sealed by a film casing 5.

Each of the positive electrodes 10 includes positive electrode active substance layers 13 formed on a positive electrode collector 11 that may typically be made of aluminum foil. Each of the negative electrodes 20 has a surface area greater than each of the positive electrodes 10 and includes a negative electrode active substance 23 formed on a negative electrode collector 21 that may typically be made of copper foil.

Positive electrode draw-out terminals 19 and negative electrode draw-out terminals 29 are respectively thermally bonded together at the opening to be sealed 7 of the film casing 5 and drawn out to the outside. The opening to be sealed 7 is sealed in a decompressed state after injecting electrolyte into the inside so that the battery element produced by laying the positive electrodes, the separators and the negative electrodes one on the other is pressed by the film casing due to the pressure difference between the outside and the inside produced as a result of the decompression of the inside.

The positive electrode active substance to be used for the purpose of the present invention can be selected from lithium-containing transition metal oxides including lithium cobalt oxide, lithium nickel oxide and lithium manganese oxide.

Typical lithium cobalt oxide that can be used for the purpose of the present invention is popular LiCoO₂ that has a flat region at or about 4V of the electric potential relative to a metal lithium counter electrode. The lithium cobalt oxide may be modified at the surface by Mg, Al or Zr or the cobalt sites of the crystal structure may be doped with or substituted by such an element in order to improve the thermal stability of the lithium cobalt oxide and prevent the crystal structure from becoming unstable if lithium is drawn out to a large extent from the lithium cobalt oxide.

Typical lithium nickel oxide is LiNi₁₋ₓCoₓO₂ obtained by substituting part of the nickel sites of lithium nickel oxide or LiNi_{1-x-y}CoₓAl_{y}O₂ obtained by additionally doping lithium nickel oxide with aluminum that has a flat region at or about 4V of the electric potential relative to the metal lithium counter electrode in order to improve the thermal stability and the cycle properties.

Typical lithium manganese oxide is Li₁₊ₓMn_{2-x-y}O_{4-z} (where 0.03≦x≦0.16, 0≦y≦0.1, −0.1≦z≦0.1, M=one or more than one elements selected from Mg, Al, Ti, Co and Ni) that has a flat region at or about 4V of the electric potential relative to the metal lithium counter electrode.

The particle profile of the lithium manganese oxide may be lumpy, spherical, laminar or of some other appropriate shape. The diameter and the specific surface area thereof may be appropriately selected by considering the thickness of the positive electrode active substance layers, the electrode density of the positive electrode active substance layers and the type of the binder.

Preferably, the particle profile, the granularity distribution, the average particle diameter, the specific surface area and the true density are selected so as to make the density of the positive electrode active substance layers not less than 2.8 g/cm³ in order to keep the energy density to a high level.

For the purpose of the present invention, the density of the positive electrode active substance layers is that of the parts obtained by removing the positive electrode collectors from the positive electrodes.

Preferably, the particle profile, the granularity distribution, the average particle diameter, the specific surface area and the true density are such that the content ratio by weight of the positive electrode active substance is made not less than 80% in the positive electrode mixture that is formed by a positive electrode active substance, a binder, a conductivity imparting agent and so on.

The starting materials for synthesizing Li₁₊ₓMn_{2-x-y}O_{4-z} (where 0.03≦x≦0.16, 0≦y≦0.1, −0.1≦z≦0.1, M=one or more than one elements selected from Mg, Al, Ti, Co and Ni), which is a lithium manganese complex oxide, may be selected from lithium source materials including lithium carbonate, lithium hydroxide, lithium oxide and lithium sulfate, the largest particle diameter thereof being suitably not more than 2 micrometer from the viewpoint of improving the reactivity with a manganese source material and the crystallinity of the synthesized lithium complex oxide, and manganese source materials including manganese oxides, oxyhydroxides, carbonates and nitrates such as MnO₂, Mn₂O₃, Mn₃O₄, MnOOH, MnCO₃ and Mn(NO₃)₂ as manganese source, the largest particle diameter thereof being preferably not more than 30 micrometer.

Of the above source materials, lithium carbonate is preferable as lithium source and manganese oxides such as MnO₂, Mn₂O₃ and Mn₃O₄ are preferable as manganese sources from the viewpoint of availability and ease of handling and obtaining an active substance showing a high filling effect.

Now, the method of synthesizing lithium manganese complex oxide will be described below. The starting materials are weighted and mixed so as to provide a predetermined elemental composition ratio. At this time, the largest particle diameter of the lithium source and that of the manganese source are preferably made not more than 2 micrometer and not more than 30 micrometer respectively in order to improve the reactivity of the lithium source and the manganese source and avoid Mn₂O₃ hetero-phase from remaining. The source materials can be mixed with each other by means of a ball mill, a V-type mixer, a cutter mixer or a shaker. The obtained powdery mixture is then baked within a temperature range between 600 degree C. and 950 degree C. in an atmosphere of a pressure level not lower than the oxygen partial pressure in the air.

While only lithium manganese oxide or lithium nickel oxide may be used, they may alternatively be mixed and used. They can be mixed to a compounding ratio between 90:10 and 50:50 in terms of mass ratio.

Each of the positive electrodes are prepared by applying a mixture of the positive electrode active substance, a binder and a conductivity imparting agent such as acetylene black or carbon to a collector. The binder may be selected from appropriate binders including polyvinylidene fluoride (PVdF) and polytetrafluoroethylene (PTFE). The collector may be aluminum foil.

The negative electrode active substance to be used for the purpose of the present invention is graphite that can be used to dope and undope lithium and preferably shows a high initial charge/discharge efficiency, a high crystaillinity, an average grain diameter (D₅₀) of 15 to 50 micrometer and a BET specific surface area of 0.4 to 2.0 m²/g.

In the examples of the present invention that are described hereinafter, the BET specific surface areas are observed by means of a QUANTA SORB (specific surface area meter—available from QUANTA CHROME) under the conditions of the measurement gas: nitrogen, calibration gas: nitrogen, the sample fill ratio: ½ to ⅔ of the sample receiving glass cell and the gas purge mode: flow after pre-processing the sample at 200 degree C. in a nitrogen gas flow for 15 minutes.

The negative electrode can be prepared mixing the negative electrode active substance with a binder selected appropriately according to the properties that are considered to be important for batteries including the rate property, the output property, the low-temperature discharge property, the pulse discharge property, the energy density, the potential of weight reduction and the potential of downsizing.

While polyvinylidene fluoride (PVdF) or polytetrafluoroethylene (PTFE) can be used as binder, a rubber-based binder may alternatively be used for the purpose of the present invention.

For the purpose of the present invention, the density of the negative electrode active substance layers is characterized by being not more than 1.65 g/cm³ and not less than 0.90 g/cm³.

The value of not less than 0.90 g/cm³ is selected for the lower limit of the density of the negative electrode from the viewpoint of properly maintaining the contact of particles in the negative electrode active substance layers and degrading the cycle properties.

When the density is too high, deposits can be produced on the negative electrodes and, as the charge/discharge cycle is repeated, the deposited lithium compound can grow to break down the particles and produce surfaces that operate as new active surfaces so as to degrade the cycle properties because of an uneven current distribution at and around the deposited lithium compound.

Electrodes that show a desired density can be obtained by adjusting the thickness of the electrode active substance layers when compressing the electrodes.

The electrode density is determined by dividing the weight of the electrode active substance layers by their volume.

More specifically, the weight of a flat plate-shaped electrode having an area of 100 cm² when projected vertically onto a horizontal plane is observed and the weight is obtained by subtracting the weight of the copper foil that operates as collector from the observed weight.

The volume of the electric active substance layers is determined by using the thickness of the electrode active substance layers obtained by subtracting the thickness of the collectors from the thickness of the active substance layers. Subsequently, the density is determined from the weight and the volume of the electrode active substance layers.

Polypropylene or porous plastic film having a three-layer structure of polypropylene, polyethylene and polypropylene is used for the separators. While the thickness of the separators is not particularly limited, it is preferably from 10 micrometer to 30 micrometer when the rate property, the energy density of the battery and the mechanical strength of the battery are taken into consideration.

Solvents that can be used for the non-aqueous electrolyte include carbonates, ethers and ketones. Of these, at least a high dielectric constant solvent may be selected from ethylene carbonate (EC), propylene carbonate (PC) and γ-butyrolactone (GBL), while a low viscosity solvent may be selected from diethyl carbonate (DEC), dimethyl carbonate (DMC), ethylmethyl carbonate (EMC) and esters.

A mixture of any of the above listed solvents may also be used for the purpose of the present invention. Preferable mixture solutions include EC+DEC, EC+EMC, EC+DMC, PC+DEC, PC+EMC, PC+DMC and PC+EC+DEC.

The negative electrode active substance of the present invention is graphite. Therefore, when propylene carbonate is compounded, the mixing ratio is desirably so low that no reduction decomposition reaction of propylene carbonate itself would take place after the sulfonate ester having at least two sulfonyl groups according to the present invention is reduced prior to the propylene carbonate at the time of initial charge to form SEI (solid electrolyte interface) on the negative electrodes. When the solvent shows a low-purity level or a high water content ratio, the mixing ratio of the solvent having a potential window at the high potential side may well be raised.

The support electrolyte to be added to the electrolyte is at least one selected from LiBF₄, LiPF₆, LiClO₄, LiAsF₆, Li(CF₃SO₂)N and Li(C₂F₅SO₂)₂N, although one containing LiPF₆ is preferable. The concentration of the support electrolyte is preferably between 0.8M and 1.5M, more preferably between 0.9M and 1.2M. The sulfonate ester having at least two sulfonyl groups may be a cyclic sulfonate ester expressed by the chemical formula 1 shown below or a chain sulfonate ester expressed by the chemical formula 2 shown below:

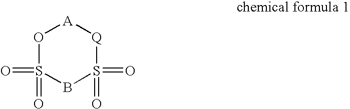

where Q is an oxygen atom, a methylene group or a single bond, A is a substituted or unsubstituted alkylene, carbonyl or sulfinyl group having 1 to 5 carbon atoms, a substituted or unsubstituted fluoroalkylene group having 1 to 6 carbon atoms or a group having 2 to 6 carbon atoms where alkylene units or fluoroalkylene units are bonded by way of an ether bond and B is a substituted or unsubstituted alkylene group, a substituted or unsubstituted fluoroalkylene group or an oxygen atom.

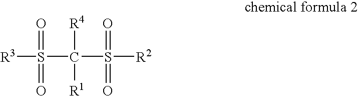

where each of R¹ and R⁴ is independently an atom or a group selected from a hydrogen atom, a substituted or unsubstituted alkyl group having 1 to 5 carbon atoms, a substituted or unsubstituted alkoxy group having 1 to 5 carbon atoms, a substituted or unsubstituted perfluoroalkyl group having 1 to 5 carbon atoms, a polyfluoroalkyl group having 1 to 5 carbon atoms, —SO₂X¹ (X¹ being a substituted or unsubstituted alkyl group having 1 to 5 carbon atoms), —SY¹ (Y¹ being a substituted or unsubstituted alkyl group having 1 to 5 carbon atoms), —COZ (Z being a hydrogen atom or a substituted or unsubstituted alkyl group having 1 to 5 carbon atoms) and a halogen atom. Each of R² and R³ is independently an atom or a group selected from a substituted or unsubstituted alkyl group having 1 to 5 carbon atoms, a substituted or unsubstituted alkoxy group having 1 to 5 carbon atoms, a substituted or unsubstituted phenoxy group, a substituted or unsubstituted perfluoroalkyl group having 1 to 5 carbon atoms, polyfluoroalkyl group having 1 to 5 carbon atoms, a substituted or unsubstituted perfluoroalkoxy group having 1 to 5 carbon atoms, polyfluoroalkoxy group having 1 to 5 carbon atoms, a hydroxyl group, a halogen atom, —NX²X³ (each of X² and X³ being independently a hydrogen atom or a substituted or unsubstituted alkyl group having 1 to 5 carbon atoms) and —NY²CONY³Y⁴ (each of Y² through Y⁴ being independently a hydrogen atom or a substituted or unsubstituted alkyl group having 1 to 5 carbon atoms).

Typical exemplary compounds expressed by the above chemical formula 1 and those expressed by the above chemical formula 2 are listed below, although the present invention is by no means limited to them.

TABLE 1

| Compound | Chemical |
|---|---|
| Number | structure |
| 1 | 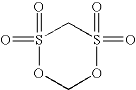 |
| 2 | 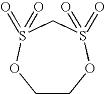 |
| 3 | 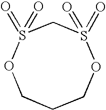 |
| 4 | 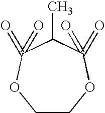 |
| 5 | 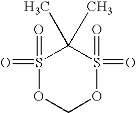 |
| 6 | 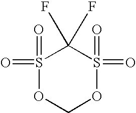 |
| 7 | 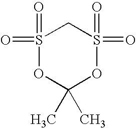 |
| 8 | 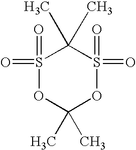 |
| 9 | 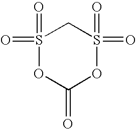 |
| 10 | 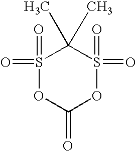 |
| 11 | 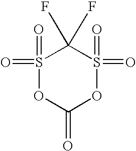 |
| 12 | 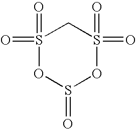 |
| 13 | 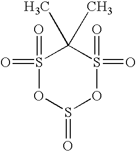 |
| 14 | 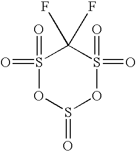 |
| 15 | 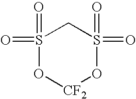 |
| 16 | 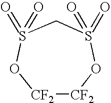 |
| 17 | 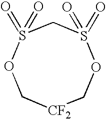 |
| 18 | 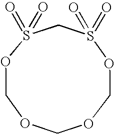 |
| 19 | 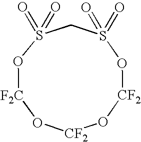 |
| 20 | 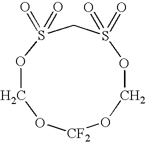 |
| 21 | 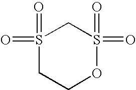 |
| 22 | 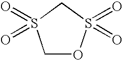 |

TABLE 1

| Compound | Chemical |
|---|---|
| Number | structure |
| 101 | 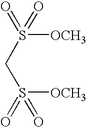 |
| 102 | 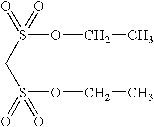 |
| 103 | 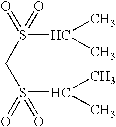 |
| 104 | 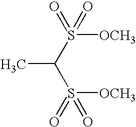 |
| 105 | 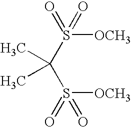 |
| 106 | 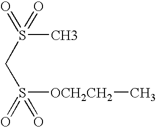 |
| 107 | 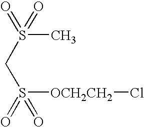 |
| 108 | 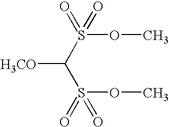 |
| 109 | 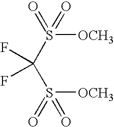 |
| 110 | 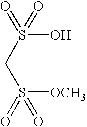 |
| 111 | 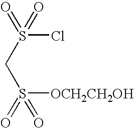 |
| 112 | 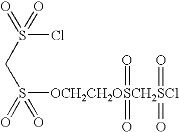 |
| 113 | 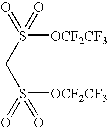 |
| 114 | 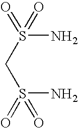 |
| 115 | 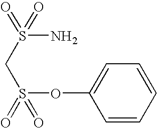 |
| 116 | 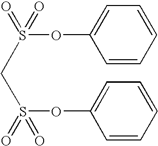 |
| 117 | 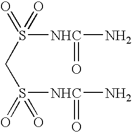 |
| 118 | 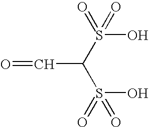 |
| 119 | 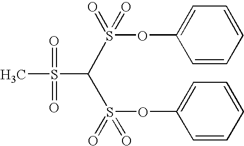 |
| 120 | 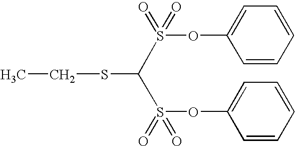 |

The electrolyte volume is preferably not less than 1.25 times and not more than 1.65 times of the void volume that the positive electrodes, the negative electrodes and the separators have. The cycle properties are degraded when the magnifying rate is lower than the above lower limit and hence the electrolyte volume is relatively small, whereas a lithium compound is apt to be produced on the negative electrode to also degrade the cycle properties when the magnifying rate is higher than the above upper limit and hence the any of the electrolyte is relative large.

As for the void volume of the electrodes, the true density that each of the component materials has is determined as the average of the observed values of 10 observations by means of a gas substitution densitometer (Penta-Pycnometer available for QUANTA CHROME), using helium and a gas purge mode of flow. Then, the difference between the volume expressed by the product of the area and the thickness and the volume determined from the true density and the weight is determined as the volume of the voids existing as space. The void volume of the separators can also be determined by computations on the basis of the weight and the film thickness.

### EXAMPLES

### Example 1

### Preparation of Lithium Ion Secondary Battery

A positive electrode active substance that was a mixture obtained by mixing lithium manganeate and lithium nickel oxide to a mass ratio of 80:20 was then dry-mixed with a conductivity imparting agent and the final mixture was homogeneously dispersed into N-methyl-2-pyrrolidone (NMP), in which polyvinylidene fluoride (PVdF) that operates as binder was dissolved, to prepare slurry. The obtained slurry was applied to 20 micrometer-thick aluminum foil and subsequently the NMP was driven off to produce positive electrodes.

The solid content ratio of the positive electrodes was such that lithium manganese oxide:lithium nickel oxide:conductivity imparting agent: PVdF=72:18:6:4 in terms of mass ratio.

Each of the positive electrodes was made to show a width of 55 mm and a height of 100 mm and the part of the aluminum foil where no positive electrode active substance was applied was punched out to form a current draw-out part that showed a width of 10 mm and a height of 15 mm.

A negative electrode active substance that was graphite was homogeneously dissolved into N-methyl-2-pyrrolidone (NMP), in which polyvinylidene fluoride (PVdF) was dissolved, to prepare slurry. The obtained slurry was applied to 10 micrometer-thick copper foil and subsequently the NMP was driven off to produce negative electrodes. The used graphite showed an average particle diameter (D50) of 31 micrometer and a BET specific surface area of 0.8 m²/g. The solid content ratio of the negative electrode active substance layers was such that graphite: PVdF=90:10 in terms of mass ratio.

Each of the negative electrodes was made to show a width of 59 mm and a height of 104 mm and part of the copper foil where no negative electrode active substance was applied was punched out to form a current draw-out part that showed a width of 10 mm and a height of 15 mm.

A total of 14 negative electrodes, each having a negative electrode active substance layer of a density of 0.90 g/cm³, were prepared. The total void volume of the negative electrodes was 12.30 cm³. Similarly, a total of 13 positive electrodes were prepared. The total void volume of the positive electrodes was 3.92 cm³. Finally, a total of 26 separators having 25 micrometer-thickness and a three-layer structure of polypropylene, polyethylene and polypropylene were prepared. The total void volume of the separators was 2.34 cm³.

Then, a stacked body was prepared by alternately laying the positive electrodes and the negative electrodes by way of the separators in such a way that the parts where no electrode active substance was applied were arranged at a same side. At this time, aluminum external current draw-out tabs were bonded to the respective positive electrodes by ultrasonic welding, while nickel external current draw-out tabs were bonded to the respective negative electrodes also by ultrasonic welding. A film casing formed by laying polyethylene/aluminum foil/polyethyleneterephthalate film was embossed at a side to match the profile of the stacked body and thermally bonded to another plate-like film casing and sealed.

An electrolyte prepared by using 1 mol/L LiPF₆ that operates as support electrolyte and a solvent of a mixture solution of ethylene carbonate (EC): diethyle carbonate (DEC)=30:70 (volume ratio) was employed by 26.9 cm³. This electrolyte volume was 1.45 times of the total void volume of the positive electrode, the negative electrodes and the separators.

A cyclic sulfonate ester having at least two sulfonyl groups, which is listed in Table 1 with the compound No. 1, was added to a ratio of 1.6 mass %.

The prepared lithium ion secondary battery was charged for a constant current charge with a constant current of 0.2 C to 4.2V and subsequently for a constant voltage charge until the total charging time got to 10 hours.

### Example 2

A lithium ion secondary battery was prepared as in Example 1 except that the density of the negative active substance layers of the negative electrodes was made equal to 1.20 g/cm³ and the volume of the electrolyte was made to be 1.45 times of the void volume.

### Example 3

A lithium ion secondary battery sealed by film casings was prepared as in Example 1 except that the density of the negative active substance layers of the negative electrodes was made equal to 1.55 g/cm³ and the volume of the electrolyte was made to be 1.45 times of the void volume.

### Example 4

A lithium ion secondary battery sealed by film casings was prepared as in Example 1 except that the density of the negative active substance layers of the negative electrodes was made equal to 1.65 g/cm³ and the volume of the electrolyte was made to be 1.45 times of the void volume.

### Example 5

A lithium ion secondary battery sealed by film casings was prepared as in Example 1 except that a compound with the compound No. 4 in Table 1 was used as a sulfonate ester having at least two sulfonyl groups.

### Example 6

A lithium ion secondary battery sealed by film casings was prepared as in Example 2 except that a compound with the compound No. 9 in Table 1 was used as a sulfonate ester having at least two sulfonyl groups.

### Comparative Example 1

A lithium ion secondary battery sealed by film casings was prepared as in Example 1 except that the density of the negative active substance layers of the negative electrodes was made equal to 0.85 g/cm³ and the volume of the electrolyte was made to be 1.45 times of the void volume.

### Comparative Example 2

A lithium ion secondary battery sealed by film casings was prepared as in Example 1 except that the density of the negative active substance layers of the negative electrodes was made equal to 1.70 g/cm³ and the volume of the electrolyte was made to be 1.45 times of the void volume.

### Comparative Example 3

A lithium ion secondary battery sealed by film casings was prepared as in Comparative Example 1 except that a compound with the compound No. 4 in Table 1 was used as a sulfonate ester having at least two sulfonyl groups.

### Comparative Example 4

A lithium ion secondary battery sealed by film casings was prepared as in Comparative Example 1 except that a compound with the compound No. 9 in Table 1 was used as a sulfonate ester having at least two sulfonyl groups.

Surface Observation of Negative Electrode Active Substance Layers after Initial Charge/Discharge

The lithium ion secondary batteries sealed by film casings and prepared respectively under the above-described conditions were decomposed after the initial charge/discharge and the surfaces of the negative electrode active substance layers were observed.

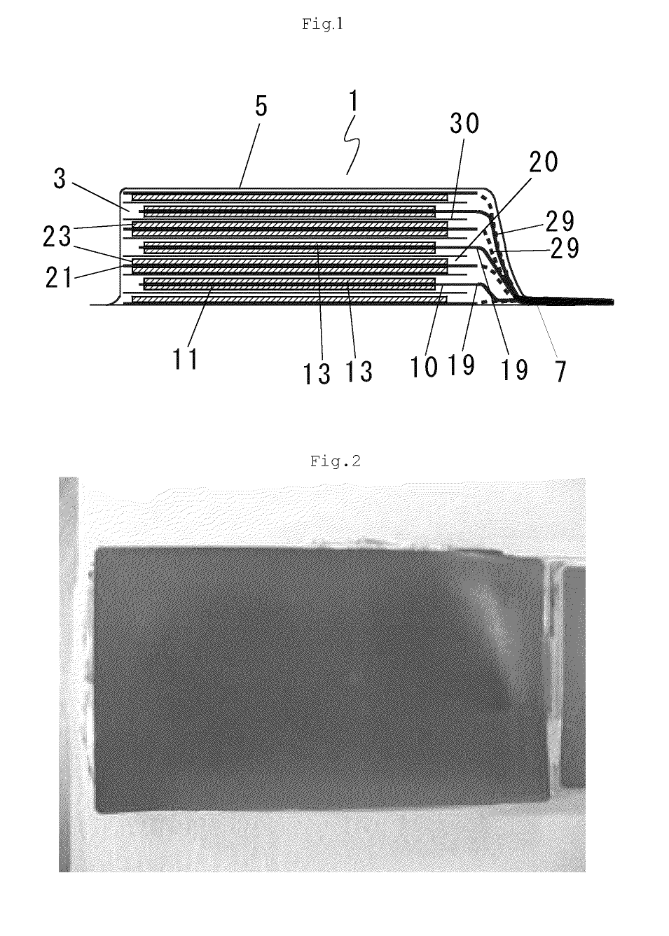

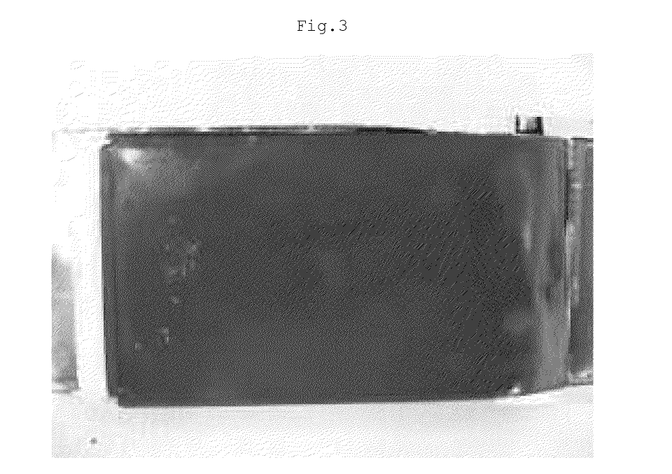

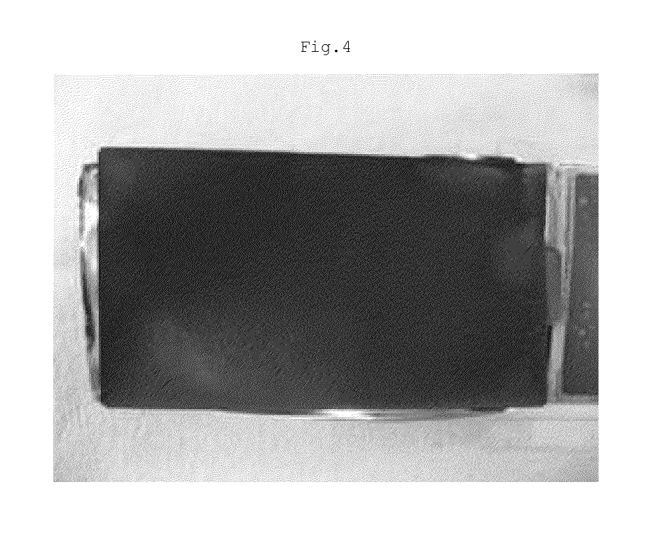

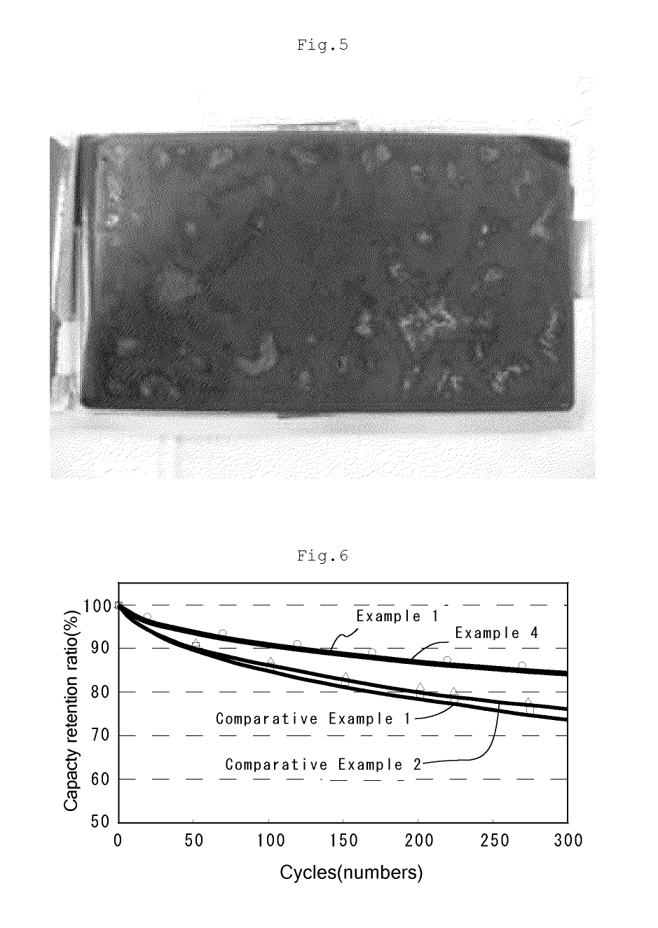

FIGS. 2 through 5 show the surfaces of some of the negative electrode active substance layers. FIG. 2 shows the surface of a negative electrode active substance layer of Example 1. FIG. 3, FIG. 4 and FIG. 5 respectively shows the surfaces of negative electrode active substance layers of Example 4, Comparative Example 1 and Comparative Example 2. FIGS. 2 through 4 illustrate that no deposit was observed on the related negative electrode active substance layers.

On the other hand, deposit was observed on the negative electrode active substance layers of Comparative Example 2 shown in FIG. 5. The deposit was looked into for the bond energy of Li (1S) by means of an X-ray photoelectron spectrometer (Quantum 2000: available from ULVAC-PHI) under the conditions of X-ray source: monochromatization Al—K alpha (1486.6 eV), beam diameter: 50 micro meter and power output: 12.5 W.

A peak was observed at 55.6 eV to prove that the deposit was not metal lithium (54.7 eV) but a lithium compound. Additionally, it was found that the deposit was a highly reactive lithium compound because a reaction that entails gas generation was observed when water was dropped on the deposit.

Cycle Properties Test

The lithium ion secondary batteries sealed by film casings and prepared respectively under the above-described conditions were subjected to a cycle properties test of repeating a cycle of a constant current charge with a constant current value of 1 C to 4.2V, a subsequent constant voltage charge until the total charging time got to 2.5 hours and a constant current discharge down to 3.0V with a current value of 1 C up to 300 cycles at temperature of 45 degrees C. in order to evaluate the cycle properties thereof.

FIG. 6 shows the results of the cycle properties test of Examples 1 and 4 and Comparative Examples 1 and 2. Table 3 shows the results of the cycle properties test of Examples 1 through 6 and Comparative Examples 1 through 4. The capacity retention ratio after 300 cycles is the value obtained by dividing the discharge capacity after 300 cycles by the discharge capacity at the 10th cycle.

TABLE 3

| | Negative | Compound ratio | | | |
|---|---|---|---|---|---|
| | electrode | of additive in | | | |
| | active | electrolyte | | | |
| | substance | | Compound | | Capacity |
| | density | Compound | ratio | Deposit | retention |
| | (g/cm³) | No. | (mass %) | found | ratio (%) |
| Example 1 | 0.90 | 1 | 1.6 | No | 84.5 |
| Example 2 | 1.20 | 1 | 1.6 | No | 85.2 |
| Example 3 | 1.55 | 1 | 1.6 | No | 85.1 |
| Example 4 | 1.65 | 1 | 1.6 | No | 84.9 |
| Example 5 | 0.90 | 4 | 1.6 | No | 84.7 |
| Example 6 | 0.90 | 9 | 1.6 | No | 84.5 |
| Comp. | 0.85 | 1 | 1.6 | No | 72.3 |
| Example 1 | | | | | |
| Comp. | 1.70 | 1 | 1.6 | Yes | 76.5 |
| Example 2 | | | | | |
| Comp. | 0.85 | 4 | 1.6 | No | 70.7 |
| Example 3 | | | | | |
| Comp. | 0.85 | 9 | 1.6 | No | 71.5 |
| Example 4 | | | | | |

From the above results, it was found that the lithium compound deposited on the negative electrode active substance layers and the cycle properties were degraded when the density of the negative electrode active substance layers exceeds 1.65 g/cm³ to become 1.70 g/cm³. On the other hand, while the lithium compound did not deposit on the negative electrode active substance layers, the cycle properties were also degraded when the density of the negative electrode active substance layers fell below 0.90 g/cm³ to become 0.85 g/cm³. The inventors believe that the particles of the active substance become to show a high contact resistance and hence poorly contact each other when the electrode density is too low and also when the number of times of repetition of a charge/discharge cycle becomes too high.

From the above results, it became clear that a lithium ion secondary battery operates effectively when a cyclic sulfonate ester having at least two sulfonyl groups is employed as additive to the electrolyte and the density of the negative electrode active substance layers is not less than 0.90 g/cm³ and not more than 1.65 g/cm³.

### Example 7

An electrolyte was prepared by adding a chain sulfonate ester having at least two sulfonyl groups that is listed in Table 2 with the compound No. 101 to 1.7 mass %.

A lithium ion secondary battery sealed by film casings was prepared by using negative electrodes showing an electrode density of 0.90 g/cm³ as in Example 1 except the additive to the electrolyte.

### Example 8

A lithium ion secondary battery sealed by film casings was prepared as in Example 7 except that the density of the negative electrode active substance layers was made equal to 1.20 cm/g³.

### Example 9

A lithium ion secondary battery sealed by film casings was prepared as in Example 7 except that the density of the negative electrode active substance layers was made equal to 1.55 cm/g³.

### Example 10

A lithium ion secondary battery sealed by film casings was prepared as in Example 7 except that the density of the negative electrode active substance layers was made equal to 1.65 cm/g³.

### Example 11

A lithium ion secondary battery sealed by film casings was prepared as in Example 7 except that a compound with the compound No. 102 in Table 2 was used as a sulfonate ester having at least two sulfonyl groups.

### Example 12

A lithium ion secondary battery sealed by film casings was prepared as in Example 7 except that a compound with the compound No. 116 in Table 2 was used as a sulfonate ester having at least two sulfonyl groups.

### Comparative Example 5

A lithium ion secondary battery sealed by film casings was prepared as in Example 7 except that the density of the negative electrode active substance layers was made equal to 0.85 cm/g³.

### Comparative Example 6

A lithium ion secondary battery sealed by film casings was prepared as in Example 7 except that the density of the negative electrode active substance layers was made equal to 1.70 cm/g³.

### Comparative Example 7

A lithium ion secondary battery sealed by film casings was prepared as in Example 5 except that a compound with the compound No. 102 in Table 2 was used as a sulfonate ester having at least two sulfonyl groups.

### Comparative Example 8

A lithium ion secondary battery sealed by film casings was prepared as in Example 5 except that a compound with the compound No. 116 in Table 2 was used as a sulfonate ester having at least two sulfonyl groups.

Surface Observation of Negative Electrode Active Substance Layers after Initial Charge/Discharge

The lithium ion secondary batteries sealed by film casings and prepared respectively under the above-described conditions were decomposed after the initial charge/discharge and the surfaces of the negative electrode active substance layers were observed. As a result, no deposit was detected on the negative electrode active substance layers of the lithium ion secondary batteries of Examples 7 through 12 and Comparative Examples 5, 7 and 8. On the other hand, deposit was detected on the negative electrode active substance layers of Comparative Example 6 and found to be not lithium metal but a lithium compound by an XPS analysis as in Comparative Example 2.

Cycle Properties Test

The lithium ion secondary batteries sealed by film casings and prepared respectively under the above-described conditions were charged for a constant current charge with a constant current of 1 C to 4.2V and a subsequent constant voltage charge until the total charging time got to 2.5 hours at temperature of 45 degree C.

Thereafter, the batteries were discharged for a constant current discharge down to 3.0V with a current value of 1 C as in Example 1. The capacity retention ratios of the batteries after 300 cycles were shown in Table 4 below. The capacity retention ratio after 300 cycles is the value obtained by dividing the discharge capacity after 300 cycles by the discharge capacity at the 10th cycle.

TABLE 4

| | Negative | Compound ratio | | | |
|---|---|---|---|---|---|
| | electrode | of additive in | | | |
| | active | electrolyte | | | |
| | substance | | Compound | | Capacity |
| | density | Compound | ratio | Deposit | retention |
| | (g/cm³) | No. | (mass %) | found | ratio (%) |
| Example 7 | 0.90 | 101 | 1.7 | No | 85.0 |
| Example 8 | 1.20 | 101 | 1.7 | No | 84.6 |
| Example 9 | 1.55 | 101 | 1.7 | No | 84.9 |
| Example | 1.65 | 101 | 1.7 | No | 85.1 |
| 10 | | | | | |
| Example | 0.90 | 102 | 1.7 | No | 84.6 |
| 11 | | | | | |
| Example | 0.90 | 116 | 1.7 | No | 84.4 |
| 12 | | | | | |
| Comp. | 0.85 | 101 | 1.7 | No | 69.7 |
| Example 5 | | | | | |
| Comp. | 1.70 | 101 | 1.7 | Yes | 72.8 |
| Example 6 | | | | | |
| Comp. | 0.85 | 102 | 1.7 | No | 67.0 |
| Example 7 | | | | | |
| Comp. | 0.85 | 116 | 1.7 | No | 68.5 |
| Example 8 | | | | | |

From the above results, it was found that the lithium compound deposited on the negative electrode active substance layers and the cycle properties were degraded as the compound No. 1 when the density of the negative electrode active substance layers exceeds 1.65 g/cm³ to become 1.70 g/cm³ when a compound with the compound No. 101 was used as additive to the electrolyte. On the other hand, while the lithium compound did not deposit on the negative electrode active substance layers, the cycle properties were also degraded when the density of the negative electrode active substance layers fell below 0.90 g/cm³ to become 0.85 g/cm³. The inventors believe that the particles of the active substance become to show a high contact resistance and hence poorly contact each other when the electrode density is too low and also when the number of times of repetition of a charge/discharge cycle becomes too high.

From the above results, it became clear that a lithium ion secondary battery operates effectively when a cyclic sulfonate ester having at least two sulfonyl groups is employed as additive to the electrolyte and the density of the negative electrode active substance layers is not less than 0.90 g/cm³ and not more than 1.65 g/cm³.

### Example 13

A lithium ion secondary battery sealed by film casings was prepared as in Example 3 except that the density of the negative electrode active substance layers was 1.55 g/cm³, that a compound with the compound No. 1 was used as a cyclic sulfonate ester having at least two sulfonyl groups and that the electrolyte volume was made equal to 1.25 times of the void volume that the positive electrodes, the negative electrodes and the separators have.

### Example 14

A lithium ion secondary battery sealed by film casings was prepared as in Example 13 except that the electrolyte volume was made equal to 1.65 times of the void volume that the positive electrodes, the negative electrodes and the separators have.

### Example 15

A lithium ion secondary battery sealed by film casings was prepared as in Example 14 except that a compound with the compound No. 4 in Table 1 was used as a sulfonate ester having at least two sulfonyl groups.

### Example 16

A lithium ion secondary battery sealed by film casings was prepared as in Example 14 except that a compound with the compound No. 9 in Table 1 was used as a sulfonate ester having at least two sulfonyl groups.

### Comparative Example 9

A lithium ion secondary battery sealed by film casings was prepared as in Example 13 except that the electrolyte volume was made equal to 1.20 times of the void volume that the positive electrodes, the negative electrodes and the separators have.

### Comparative Example 10

A lithium ion secondary battery sealed by film casings was prepared as in Example 13 except that the electrolyte volume was made equal to 1.70 times of the void volume that the positive electrodes, the negative electrodes and the separators have.

### Comparative Example 11

A lithium ion secondary battery sealed by film casings was prepared as in Comparative Example 10 except that a compound with the compound No. 4 in Table 1 was used as a sulfonate ester having at least two sulfonyl groups.

### Comparative Example 12

A lithium ion secondary battery sealed by film casings was prepared as in Comparative Example 10 except that a compound with the compound No. 9 in Table 1 was used as a sulfonate ester having at least two sulfonyl groups.

Surface Observation of Negative Electrode Active Substance Layers after Initial Charge/Discharge

The lithium ion secondary batteries sealed by film casings and prepared respectively under the above-described conditions were decomposed after the initial charge/discharge and the surfaces of the negative electrode active substance layers were observed. As a result, deposit was observed on the negative electrode active substance layers of Comparative Examples 10 through 12. As in the case of Comparative Examples 2 and 6, the deposit was found to be not lithium metal but a lithium compound by an XPS analysis.

### Cycle Properties Test

The lithium ion secondary batteries sealed by film casings and prepared respectively under the above-described conditions were charged for a constant current charge with a constant current of 1 C to 4.2V and a subsequent constant voltage charge until the total charging time got to 2.5 hours at temperature of degree C.

Thereafter, the batteries were discharged for a constant current discharge down to 3.0V with a current value of 1 C as in Example 1. The capacity retention ratios of the batteries after 300 cycles were shown in Table 5 below. The capacity retention ratio after 300 cycles is the value obtained by dividing the discharge capacity after 300 cycles by the discharge capacity at the 10th cycle.

TABLE 5

| | | Compound ratio | | | |
|---|---|---|---|---|---|
| | Void | of additive in | | | |
| | contents | electrolyte | | | |
| | (number | | Compound | | Capacity |
| | of | Compound | ratio | Deposit | retention |
| | times) | No. | (mass %) | found | ratio (%) |
| Example 13 | 1.25 | 1 | 1.6 | No | 84.4 |
| Example 14 | 1.65 | 1 | 1.6 | No | 85.1 |
| Example 15 | 1.65 | 4 | 1.6 | No | 83.7 |
| Example 16 | 1.65 | 9 | 1.6 | No | 83.7 |
| Comp. | 1.20 | 1 | 1.6 | No | 62.8 |
| Example 9 | | | | | |
| Comp. | 1.70 | 1 | 1.6 | Yes | 82.6 |
| Example 10 | | | | | |
| Comp. | 1.70 | 4 | 1.6 | Yes | 80.2 |
| Example 11 | | | | | |
| Comp. | 1.70 | 9 | 1.6 | Yes | 80.5 |
| Example 12 | | | | | |

From the above results, when an electrolyte containing a sulfonate ester having at least two sulfonyl groups is used while graphite is used as negative electrode active substance and the electrolyte volume is less than 1.25 times of the void volume that the positive electrodes, the negative electrodes and the separators have, no deposit of lithium compound is formed on the negative electrode active substance layers but cycle properties are degraded. The inventors of the present invention believe that this is because the electrolyte volume is short of the minimally required volume for a lithium ion secondary battery that is to be operated repeatedly. On the other hand, when the electrolyte volume is more than 1.65 times of the void volume that the positive electrodes, the negative electrodes and the separators have, the inventors of the present invention believe that the electrolyte volume and hence the absolute volume of sulfonate ester are excessive so that deposit is formed on the negative electrode active substance layers. As for cycle properties, the inventors of the present invention believe that the inside of a lithium ion secondary battery according to the present invention is preferably free from any highly reactive lithium compound because such a lithium compound can adversely affect the performance of the battery when the battery is operated repeatedly over a long period of time, although the cycle properties of the battery are not degraded extremely.

Thus, from the above results, when an electrolyte containing a sulfonate ester having at least two sulfonyl groups is employed and graphite is used as negative electrode active substance, the electrolyte volume is preferably not less than 1.25 times and not more than 1.65 times of the void volume that the positive electrodes, the negative electrodes and the separators of the battery have.

### INDUSTRIAL APPLICABILITY

A lithium ion secondary battery according to the present invention shows excellent charge/discharge cycle properties and hence can usefully find applications not only in the field portable devices which is widely prevalent but also in the field of electric bicycles, electric automobiles, power tools and electric power storages.

### CITATION LIST

### Patent Literature

J P No. 4033074

JP-A-2006-351332

1. A lithium ion secondary battery comprising an aprotic electrolyte containing a sulfonate ester having at least two sulfonyl groups and graphite as principal component of negative electrode active substance layers, the density of the negative electrode active substance layers being not less than 0.90 g/cm³ and not more than 1.65 g/cm³.

2. The lithium ion secondary battery according to claim 1, wherein
the electrolyte volume is not less than 1.25 times and not more than 1.65 times of the void volume that the positive electrode, the negative electrode and the separator possess.

3. The lithium ion secondary battery according to claim 1, wherein
the sulfonate ester having at least two sulfonyl groups is a cyclic sulfonate ester expressed by chemical formula 1 shown below: 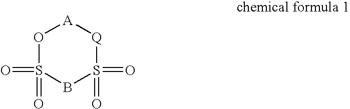
where Q is an oxygen atom, a methylene group or a single bond, A is a substituted or unsubstituted alkylene, carbonyl or sulfinyl group having 1 to 5 carbon atoms, a substituted or unsubstituted fluoroalkylene group having 1 to 6 carbon atoms or a divalent group having 2 to 6 carbon atoms where alkylene units or fluoroalkylene units are bonded by way of an ether bond and B is a substituted or unsubstituted alkylene group, a substituted or unsubstituted fluoroalkylene group or an oxygen atom.

4. The lithium ion secondary battery according to claim 1, wherein
the sulfonate ester having at least two sulfonyl groups is a chain sulfonate ester expressed by chemical formula 2 shown below: 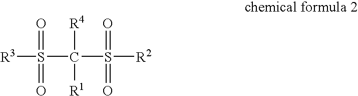
where each of R¹ and R⁴ is independently an atom or a group selected from a hydrogen atom, a substituted or unsubstituted alkyl group having 1 to 5 carbon atoms, a substituted or unsubstituted alkoxy group having 1 to 5 carbon atoms, a substituted or unsubstituted perfluoroalkyl group having 1 to 5 carbon atoms, a polyfluoroalkyl group having 1 to 5 carbon atoms, —SO₂X¹ (X¹ being a substituted or unsubstituted alkyl group having 1 to 5 carbon atoms), —SY¹ (Y¹ being a substituted or unsubstituted alkyl group having 1 to 5 carbon atoms), —COZ (Z being a hydrogen atom or a substituted or unsubstituted alkyl group having 1 to 5 carbon atoms) and a halogen atom and each of R² and R³ is independently an atom or a group selected from a substituted or unsubstituted alkyl group having 1 to 5 carbon atoms, a substituted or unsubstituted alkoxy group having 1 to 5 carbon atoms, a substituted or unsubstituted phenoxy group, a substituted or unsubstituted perfluoroalkyl group having 1 to 5 carbon atoms, polyfluoroalkyl group having 1 to 5 carbon atoms, a substituted or unsubstituted perfluoroalkoxy group having 1 to 5 carbon atoms, a substituted or unsubstituted polyfluoroalkoxy group having 1 to 5 carbon atoms, a hydroxyl group, a halogen atom, (each of X² and X³ being independently a hydrogen atom or a substituted or unsubstituted alkyl group having 1 to 5 carbon atoms) and —NY²CONY³Y⁴ (each of Y² through Y⁴ being independently a hydrogen atom or a substituted or unsubstituted alkyl group having 1 to 5 carbon atoms).
